(19) United States
(12) Patent Application Publication
(10) Pub. No.: US 2007/0168571 A1
(43) Pub. Date: Jul. 19, 2007

(54) System and method for automatic enforcement of firmware revisions in SCSI/SAS/FC systems

(75) Inventors: Scott Ramsey, Austin, TX (US); Douglas Huang, Pflugerville, TX (US); Michael Mamo, Cedar Park, TX (US)

Correspondence Address: Randall C. Furlong;Baker Botts L.L.P., One Shell Plaza, 910 Louisiana Street, Houston, TX, 77002-4995, US

(73) Assignee: DELL PRODUCTS L.P.

(21) Appl. No.: 11/265,653

(22) Filed: Nov. 2, 2005

(51) Int. Cl. G06F 3/00

(52) U.S. Cl. 710/8

(57) ABSTRACT

A system and method for automatic enforcement of firmware revision in an information handling system are disclosed. The method includes scanning an interconnection for hardware devices attached to the interconnection in an information handling system and determining an interconnection compatibility of each hardware device attached to the interconnection based on checking, verifying, and flagging a revision status of the firmware for each of the hardware devices attached to the interconnection. The method also includes displaying a warning to a user about possible compatibility issues, based on determining the interconnection compatibility of each of the hardware devices attached to the interconnection and determining whether a supported revision of firmware for each of the hardware devices attached to the interconnection is locally stored as a single uniform release, based on determining the interconnection compatibility of each of the hardware devices attached to the interconnection. The method also includes prompting the user whether to proceed with a firmware upgrade for each of the hardware devices attached to the interconnection using the locally stored supported revision of the firmware for each of the hardware devices attached to the interconnection in the single uniform release, based on determining the interconnection compatibility of each of the hardware devices attached to the interconnection and upgrading automatically the firmware for each of the hardware devices attached to the interconnection based on prompting the user.

### TECHNICAL FIELD OF THE INVENTION

The present disclosure relates generally to information handling systems and, more particularly, to a system and method for automatically enforcing firmware revision in a small computer system interface (SCSI) system and/or a serial attached SCSI (SAS) system and/or a fiber channel (FC) system.

### BACKGROUND OF THE INVENTION

As the value and use of information continues to increase, individuals and businesses continually seek additional ways to process and store information. One option available to users of information is an information handling system. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary with regard to the kind of information that is handled, how the information is handled, how much information is processed, stored, or communicated, and how quickly and efficiently the information may be processed, stored, or communicated. The variations in information handling systems allow for information handling systems to be general or configured for a specific user or specific use, including such uses as financial transaction processing, airline reservations, enterprise data storage, or global communications. In addition, information handling systems may include a variety of hardware and software components that may be configured to process, store, and communicate information and may include one or more computer systems, data storage systems, and networking systems.

One example of an information handling system is a storage system such as a small computer system interface (SCSI) storage system or a serial attached SCSI (SAS) storage system. Generally, a SCSI storage system includes a controller, hard disk drives and a SCSI accessed fault tolerant enclosure (SAF-TE). A SAS storage system may include a controller, hard disk drives and expanders that repeat or regenerate the SCSI signals and may provide electrical isolation. The SAS system typically uses a point-to-point link in lieu of a bus for the SCSI interconnector. The SCSI interconnections generally interact using an expander chip that may be transparent to the software, but not necessarily transparent to the hardware.

The SCSI and SAS storage systems typically follow a standard protocol for electronic interfacing. The protocol allows the storage system to communicate with the peripheral hardware devices such as the hard disks, tape drives, CD-ROM drives and/or DVD drives connected to the system. However, despite adhering to a specification, the connected hardware devices may develop compatibility issues with the system based on the physical configuration of the system. For example, a compatibility issue may arise when a hard disk drive is moved from being attached to an internal backplane of a SCSI server to an attached enclosure. Because the internal backplane and enclosure use the same drive carrier, the hard disk drive is easily relocated between the different locations. However, by moving the hard disk drive between the locations, the physical configuration of the storage system is altered. Based on the new configuration, the hard disk drive may not function properly. For example, based on the new configuration, the hard disk drive may cause data loss that results in customer dissatisfaction. Data loss may occur because the physical interconnect is different between the internal backplane of the SCSI server and the attached external enclosure, for example.

Many information handling systems include one or more devices that process and/or operate on the basis of firmware embedded in or near the device. These devices may include hard disk drives (HDDs), CD-ROM drives, DVD drives, and various other devices and the like that include controllers driven by firmware. Firmware is the program code embedded in a storage device and maintained within or near the device. The firmware for a device most often comprises the operational code for the device. Firmware is often stored in flash memory, which describes a class of memory that is erasable and is able to hold its content without power. From time to time, it may be necessary and/or desirable to update or upgrade the firmware of a device. A firmware upgrade may be necessary to correct errors in, and/or improve the performance of, the device. The process of updating the firmware of a device is sometimes referred to as “flashing” the device, as the firmware update program will replace the software image stored in the flash memory with a second software image.

Examples of information handling systems, such as computers, including servers and workstations, are often grouped in clusters to perform specific tasks. A server cluster is a group of independent servers that is managed as a single system and is characterized by higher availability, manageability, and scalability, as compared with groupings of unmanaged servers. A server cluster typically involves the configuration of a group of independent servers such that the servers appear in the network as a single machine or unit. Server clusters are often managed as a single system, share a common namespace on the network, and are designed specifically to tolerate component failures and to support the addition or subtraction of components in the cluster in a transparent manner. At a minimum, a server cluster includes two or more servers that are connected to one another by a network. The server cluster may include software driven methods by which each client of the server cluster may access the data stored in or controlled by a server of the server cluster. One software application that is used to manage the operation of a server cluster is Microsoft Cluster Service (MSCS), which is produced by the Microsoft Corporation of Redmond, Wash.

In some server cluster configurations, many components of the server cluster are redundant, allowing the component to be replaced or upgraded while the server cluster is online in the network and without affecting the operations and/or services provided by the server cluster to the clients on the network. Server clusters often include a shared storage element in which each drive of shared storage is accessible by each node, or server, of the server cluster. From time to time, the firmware associated with the storage drives comprising the shared storage must be updated. The process of updating the firmware of a storage drive may involve taking the storage drive down or offline and updating the firmware. This step may be followed by a reboot of the storage drive in which the storage drive is placed back in service in the shared storage of the server cluster.

The firmware update process often involves the necessity of taking offline the entire shared storage unit of the server cluster. The step of taking the shared storage of the server cluster offline for the purpose of updating the firmware of the storage drives of shared storage may occur on a scheduled basis or on an as-needed basis. Taking all of the shared storage of a server cluster offline is problematic in that server clusters often host critical applications that require high data availability. Taking the shared storage of the server cluster offline increases the downtime for critical, hosted applications that require uninterrupted operation and availability of shared storage. Because the shared storage of the cluster server is offline, the nodes of the server cluster will be unable to access the shared storage. Because of the difficulties involved in taking a critical application offline, many organizations choose not to update storage drive firmware, causing the storage drives of the shared storage to operate with firmware that is out of date or faulty, thereby degrading the operation of the entire server cluster.

The shared storage of the server cluster may include fault tolerant data storage. One example of fault tolerant data storage is a redundant array of independent disks (RAID) storage system. RAID storage systems combine multiple disks into an array of disk drives to obtain performance, capacity, and reliability advantages. RAID Level 5 is an example of a fault tolerant data storage system. A RAID Level 5 storage system is characterized by the striping of data across the disks of the storage system. A set of parity bits generated by an exclusive-OR of the striped data bits is stored on a disk that is separate from the striped data. The parity bits for the respective stripes of data are distributed in the disks of the storage system so that each disk will likely contain both data bits for a stripe of data and parity bits related to some other stripe of data. In a RAID Level 5 storage system, it is typical that no single disk includes all of the parity bits or all of the data bits. RAID Level 5 is often referred to as a rotating parity storage system. If a disk of a RAID Level 5 storage system fails, the data (including the data bits and/or the parity bits) can be rebuilt by performing an exclusive-OR operation with the data of the other disks in the stripe, including the parity bits associated with the data stripe. Other RAID levels may be implemented for fault tolerance, including RAID 10, RAID 1, RAID 3, RAID 6, and the like, for example.

In certain information handling systems, SCSI/SAS storage subsystems may include devices like hard disks, controllers, expanders, and/or management devices such as SAF-TE. Although these devices may all communicate via the SCSI and/or the SAS, there are frequently compatibility issues that arise when two of these devices communicate, or attempt to communicate, with each other. Often these communication issues are able to be fixed in software code residing in each device, known as firmware. However, the firmware in one or more of these devices may need to be updated and/or upgraded.

### SUMMARY OF THE INVENTION

In accordance with the present disclosure, a system and method for automatic enforcement of firmware revision in an information handling system are disclosed. The method includes scanning an interconnection for hardware devices attached to the interconnection in an information handling system and determining an interconnection compatibility of each hardware device attached to the interconnection based on checking, verifying, and flagging a revision status of the firmware for each of the hardware devices attached to the interconnection. The method also includes displaying a warning to a user about possible compatibility issues, based on determining the interconnection compatibility of each of the hardware devices attached to the interconnection and determining whether a supported revision of firmware for each of the hardware devices attached to the interconnection is locally stored as a single uniform release, based on determining the interconnection compatibility of each of the hardware devices attached to the interconnection. The method also includes prompting the user whether to proceed with a firmware upgrade for each of the hardware devices attached to the interconnection using the locally stored supported revision of the firmware for each of the hardware devices attached to the interconnection in the single uniform release, based on determining the interconnection compatibility of each of the hardware devices attached to the interconnection and upgrading automatically the firmware for each of the hardware devices attached to the interconnection based on prompting the user.

The system for automatic enforcement of firmware revision in an information handling system that comprises at least one of a small computer system interface (SCSI) subsystem, a serial attached SCSI (SAS) subsystem, and a fiber channel (FC) subsystem includes a host bus adapter (HBA) comprising a SCSI input/output (I/O) processor and a SCSI target firmware storage and a SCSI interconnection communicatively coupled to the host bus adapter (HBA). The system also includes a plurality of hardware devices communicatively coupled to the SCSI interconnection communicatively coupled to the host bus adapter (HBA), wherein the host bus adapter (HBA) is operable to update firmware in the plurality of the hardware devices communicatively coupled to the SCSI interconnection communicatively coupled to the host bus adapter (HBA), the host bus adapter (HBA) capable of automatically pushing the firmware in a single flash process to the plurality of the hardware devices communicatively coupled to the SCSI interconnection communicatively coupled to the host bus adapter (HBA).

The system and method disclosed herein are advantageous in that upon the discovery of a supported but down revision hardware device, with non-updated firmware, attached to an interconnection in an information handling system, a host bus adapter (HBA), for example, in the information handling system may prompt the user and then proceed with a firmware upgrade that brings the supported hardware device to a known compatible firmware revision, compatible with other hardware devices also attached to the interconnection in the information handling system. The system and method disclosed herein are further advantageous in that there may also be an improvement in the user or customer experience. For example, since the host bus adapter (HBA) has the ability to update all of the hardware devices attached to the small computer system interface (SCSI) bus and/or the serial attached SCSI (SAS) point-to-point link, the user and/or customer does not have to use separate software tools to flash individual hardware devices. Users and/or customers may do only one single flash process and the host bus adapter (HBA) will automatically push firmware out to the respective hardware devices as needed. Moreover, at the end of the upgrade process, users and/or customers may be using a storage array in an information handling system, for example, having all the hardware devices therein in a known compatible state. Other technical advantages will be apparent to those of ordinary skill in the art having the benefit of the present disclosure and in view of the following specification, claims, and drawings.

### BRIEF DESCRIPTION OF THE DRAWINGS

The following figures form part of the present specification and are included to further demonstrate certain aspects of the present invention, and should not be used to limit or define the present invention. The present invention may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which the leftmost significant digit(s) in the reference numerals denote(s) the first figure in which the respective reference numerals appear, wherein:

FIG. 1 schematically illustrates a block diagram showing an information handling system, according to teachings of the present disclosure;

FIG. 2 schematically illustrates a block diagram showing an exemplary embodiment of a storage system including a controller mounted on an internal backplane having hard disk drives (HDD) and a stand-alone enclosure coupled to the controller having additional HDD connected via a SCSI bus, according to teachings of the present disclosure;

FIG. 3 schematically illustrates a block diagram showing an exemplary embodiment of a storage system including a controller mounted on an internal backplane having hardware devices such as HDD connected via a point-to-point link, according to teachings of the present disclosure;

FIG. 4 schematically illustrates a block diagram of a server cluster network;

FIG. 5 schematically illustrates a block diagram of a shared storage unit;

FIG. 6 schematically illustrates a diagram of a drive array;

FIG. 7 schematically illustrates creating a single release that contains firmware code for all the pieces of a storage subsystem;

FIG. 8 schematically illustrates a host bus adapter (HBA) having a local storage device that contains firmware code for all the pieces of a storage subsystem;

FIG. 9 schematically illustrates a flow chart for automatically enforcing fixes for firmware compatibility issues of supported devices on a SCSI bus and/or an SAS point-to-point link, according to teachings of the present disclosure; and

FIG. 10 schematically illustrates a method for automatic enforcement of firmware revision in an information handling system, according to teachings of the present disclosure.

It is to be noted, however, that the appended drawings illustrate only typical embodiments of the present invention and are, therefore, not to be considered limiting of the scope of the present invention, as the present invention may admit to other equally effective embodiments.

### DETAILED DESCRIPTION OF EXEMPLARY EMBODIMENTS OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Illustrative embodiments of the present invention are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

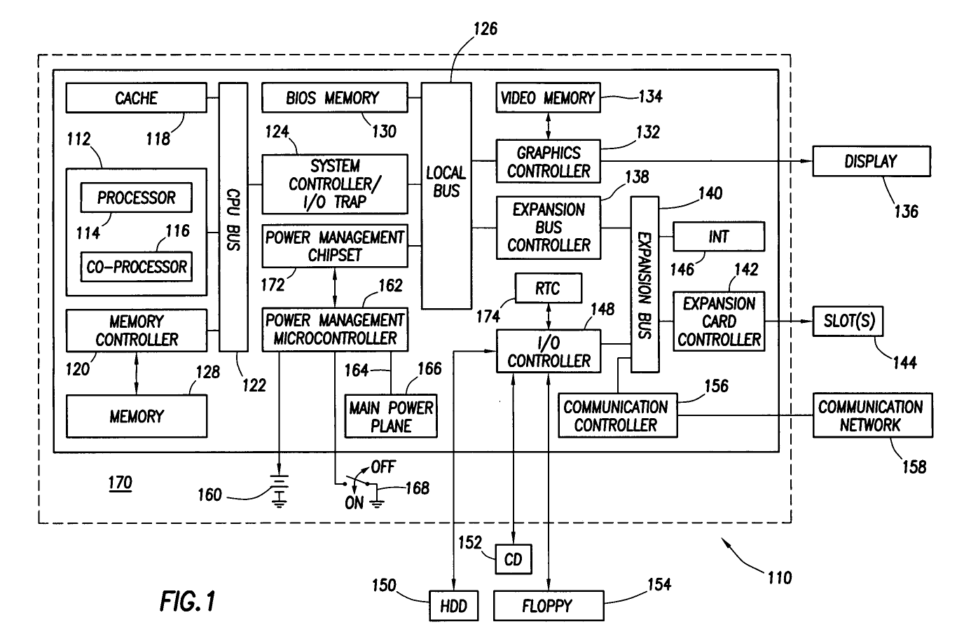

Referring first to FIG. 1, a block diagram of an information handling system 110 is shown, according to teachings of the present disclosure. The information handling system 110 or the computer system 110 preferably may include at least one microprocessor or central processing unit (CPU) 112. The CPU 112 may include a processor 114 for handling integer operations and a co-processor 116 for handling floating point operations. The CPU 112 may preferably be coupled to a cache 118 and a memory controller 120 via a CPU bus 122. A system controller input/output (I/O) trap 124 preferably may couple the CPU bus 122 to a local bus 126 and may be generally characterized as part of a system controller.

A main memory 128 of dynamic random access memory (DRAM) modules may preferably be coupled to the CPU bus 122 by the memory controller 120. The main memory 128 may be divided into one or more areas such as a system management mode (SMM) memory area (not expressly shown).

A basic input/output system (BIOS) memory 130 may also preferably be coupled to the local bus 126. A FLASH memory or other nonvolatile memory may be used as the BIOS memory 130. A BIOS program (not expressly shown) may typically be stored in the BIOS memory 130. The BIOS program preferably may include software that facilitates interaction with and between the information handling system 110 devices such as a keyboard (not expressly shown), a mouse (not expressly shown), and/or one or more I/O devices. The BIOS memory 130 may also store system code (note expressly shown) operable to control a plurality of basic information handling system 110 operations.

A graphics controller 132 may preferably be coupled to the local bus 126 and to a video memory 134. The video memory 134 may preferably be operable to store information to be displayed on one or more display panels 136. The display panel 136 may be an active matrix or passive matrix liquid crystal display (LCD), a cathode ray tube (CRT) display, and/or another display technology. In selected applications, uses and/or instances, the graphics controller 132 may also be coupled to an integrated display, such as in a portable information handling system implementation.

A bus interface controller or expansion bus controller 138 may preferably couple the local bus 126 to an expansion bus 140. In various illustrative embodiments, the expansion bus 140 may be configured as an industry standard architecture (ISA) bus. Other buses, for example, a peripheral component interconnect (PCI) bus, may also be used.

In certain information handling system 110 embodiments, an expansion card controller 142 may also be included and may preferably be coupled to the expansion bus 140 as shown in FIG. 1. The expansion card controller 142 may preferably be coupled to a plurality of information handling system 110 expansion slots 144. The expansion slots 144 may be configured to receive one or more computer components (not expressly shown) such as an expansion card (e.g., modems, fax cards, communications cards, and/or other I/O devices).

An interrupt request generator 146 may also preferably be coupled to the expansion bus 140. The interrupt request generator 146 may preferably be operable to issue an interrupt service request over a predetermined interrupt request line in response to receipt of a request to issue an interrupt instruction from the CPU 112.

An I/O controller 148, often referred to as a super I/O controller 148, may also preferably be coupled to the expansion bus 140. The I/O controller 148 may preferably interface to an integrated drive electronics (IDE) hard drive device (HDD) 150, a compact disk-read only memory (CD-ROM) drive 152, and/or a floppy disk drive (FDD) 154. Other disk drive devices (not expressly shown) that may be interfaced to the I/O controller 148 include a removable hard drive, a zip drive, a CD-RW (compact disk-read/write) drive, and a CD-DVD (compact disk-digital versatile disk) drive.

A communication controller 156 may preferably be provided and may enable the information handling system 110 to communicate with a communication network 158, for example, an Ethernet network. The communication network 158 may include a local area network (LAN), a wide area network (WAN), the Internet, an Intranet, wireless broadband, and the like. The communication controller 156 may be employed to form a network interface for communicating with other information handling systems (not expressly shown) coupled to the communication network 158.

As shown in FIG. 1, the information handling system 110 may preferably include a power supply 160, which may provide power to the many components and/or devices that form the information handling system 110. The power supply 160 may be a rechargeable battery, such as a nickel metal hydride (NiMH) or a lithium ion battery, when the information handling system 110 is embodied as a portable or notebook computer, an A/C (alternating current) power source, an uninterruptible power supply (UPS) or other power source.

The power supply 160 may preferably be coupled to a power management microcontroller 162. The power management microcontroller 162 may preferably control the distribution of power from the power supply 160. More specifically, the power management microcontroller 162 may preferably include a power output 164 coupled to a main power plane 166 that may supply power to the CPU 112 as well as to other information handling system 110 components. The power management microcontroller 162 may also be coupled to a power plane (not expressly shown) operable to supply power to an integrated panel display (not expressly shown), as well as to additional power delivery planes that preferably may be included in the information handling system 110.

The power management microcontroller 162 may preferably monitor a charge level of an attached battery and/or a UPS to determine when and when not to charge the battery or the UPS. The power management microcontroller 162 may preferably also be coupled to a main power switch 168, which the user may actuate to turn the information handling system 110 on and off. While the power management microcontroller 162 may power down one or more portions or components of the information handling system 110, for example, the CPU 112, the display 136, and/or the HDD 150, and the like, when not in use to conserve power, the power management microcontroller 162 itself may preferably be substantially always coupled to a source of power, preferably the power supply 160.

A computer system, a type of information handling system 110, may also include a power management chip set 172. The power management chip set 172 may preferably be coupled to the CPU 112 via the local bus 126 so that the power management chip set 172 may receive power management and control commands from the CPU 112. The power management chip set 172 may preferably be connected to a plurality of individual power planes operable to supply power to respective components of the information handling system 110, for example, the HDD 150, the FDD 154, and the like. In this manner, the power management chip set 172 may preferably act under the direction of the CPU 112 to control the power supplied to the various power planes and components of a system.

A real-time clock (RTC) 174 may also be coupled to the I/O controller 148 and the power management chip set 172. Inclusion of the real-time clock (RTC) 174 may permit timed events and/or alarms to be transmitted to the power management chip set 172. The real-time clock (RTC) 174 may be programmed to generate an alarm signal at a predetermined time as well as to perform other operations.

The information handling system 110 may be associated with a chassis 170. Generally, the chassis 170 may be referred to as the computer case and/or case that encloses the some of the components within the information handling system 110. However, other components such as the CD drive 152, the floppy drive 154 and/or the HDD 150, may be placed internal to the chassis 170 and/or separately from the chassis 170 in a stand-alone enclosure (described below in more detail) and/or connected in series.

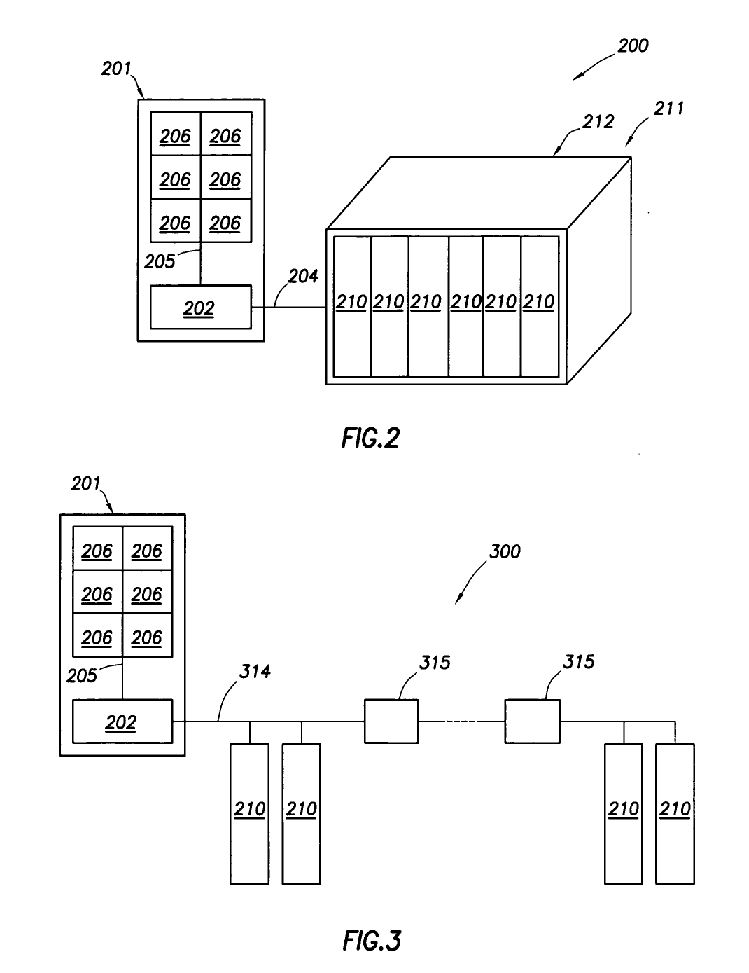

As shown in FIGS. 2 and 3, for example, one or more computer components may be communicatively connected to the information handling system 110 via a bus 204, as described below in more detail, or through a point-to-point link 314. In some embodiments, the information handling system 110 may include a storage system 200 (described below in more detail) that uses a small computer system interface (SCSI), fiber channel (FC), serial attached SCSI (SAS), and/or other standard for communications between components and/or devices and the system.

FIGS. 2 and 3 are block diagrams showing various exemplary embodiments of the storage system 200, including a small computer system interface (SCSI) storage subsystem 211 and a serial attached SCSI (SAS) and/or a fiber channel (FC) storage subsystem 300, respectively. Each storage subsystem 200 may include a controller 202 mounted on an internal backplane 201 having hard disk drives (HDDs) 206. The SCSI storage subsystem 211 may further include a stand-alone enclosure 212 that may include input/output (I/O) expanders coupled to a controller 202 having additional SCSI devices such as the HDDs 210 connected via a SCSI bus 204. The SAS/FC storage subsystem 300 may further include additional SCSI devices such as the HDDs 210 interconnected via the point-to-point SAS/FC link 314. In various illustrative embodiments, the SAS/FC storage subsystem 300 may further include one or more SCSI expanders 315 that may be operable to regenerate, reshape, and/or retransmit a SCSI signal to additional SCSI devices such as the HDDs 210 interconnected via the point-to-point SAS/FC link 314.

A SCSI/SAS/FC storage system such as storage system 200 may include a plurality of hardware and/or SCSI/SAS/FC devices such as the internal hard disk drives (HDDs) 206 and the external hard disk drives (HDDs) 210 that are connected via I/O expanders. Other examples of SCSI/SAS/FC devices may include tape drives (not expressly shown) and/or compact disk drives (not expressly shown).

The I/O expanders may allow the SCSI devices to connect to the storage system 200. The I/O expanders may include the SCSI expanders 315 that may include expander chips (not expressly shown), the internal backplane 201 and/or the enclosure 212 that may have connections for the SCSI devices to communicate with the storage system 200 via a SCSI bus such as the internal bus 205 and the external bus 204. Useful exemplary enclosures 212 may include a PowerVault 220 system and/or a PowerVault 210 system manufactured by Dell, Inc. Because the SCSI devices may reside at different locations and/or configurations within the storage system 200, the controller 202 may be used to direct communications to the address associated with each SCSI device.

The SAS/FC storage subsystem 300 may further include one or more SCSI expanders 315 that may be used to link and/or interconnect with one or more hardware devices such as the HDD 210. However, there may not necessarily be one SCSI expander 315 for each hardware device such as the hard disk drive (HDD) 210.

Each hardware and/or SCSI device within the storage system 200 may be represented as a SCSI target. Each SCSI device may include an address for communications between a processor and memory (not expressly shown) in the storage system 200 via an I/O controller such as the controller 202 shown on the internal backplane 201. The controller 202 may direct information between the SCSI devices via the internal bus 205 and/or the external bus 204.

The connections on SCSI devices may be interchangeable such that an internal SCSI device such as the internal HDD 206 may be placed in the enclosure 212, having an I/O expander. Similarly, the external HDD 210 may connect to the internal backplane 201 in lieu of the internal HDD 206.

Even though the SCSI devices may physically connect at the different locations, compatibility issues may arise such as the SCSI device may not be supported. Thus, the controller 202 may perform a scan for devices placed on interconnections such as the bus 204 and the point-to-point link 314 for devices associated with storage system 200 to identify potential compatibility issues. For example, compatibility issues may arise between a combination of the SCSI controller and an SCSI hardware device, the SCSI controller and an attached enclosure, the enclosure and an SCSI device, and the SCSI device and another SCSI device. Furthermore, firmware compatibility issues may arise such as one or more of the devices may not have the most up-to-date revision of the appropriate respective firmware.

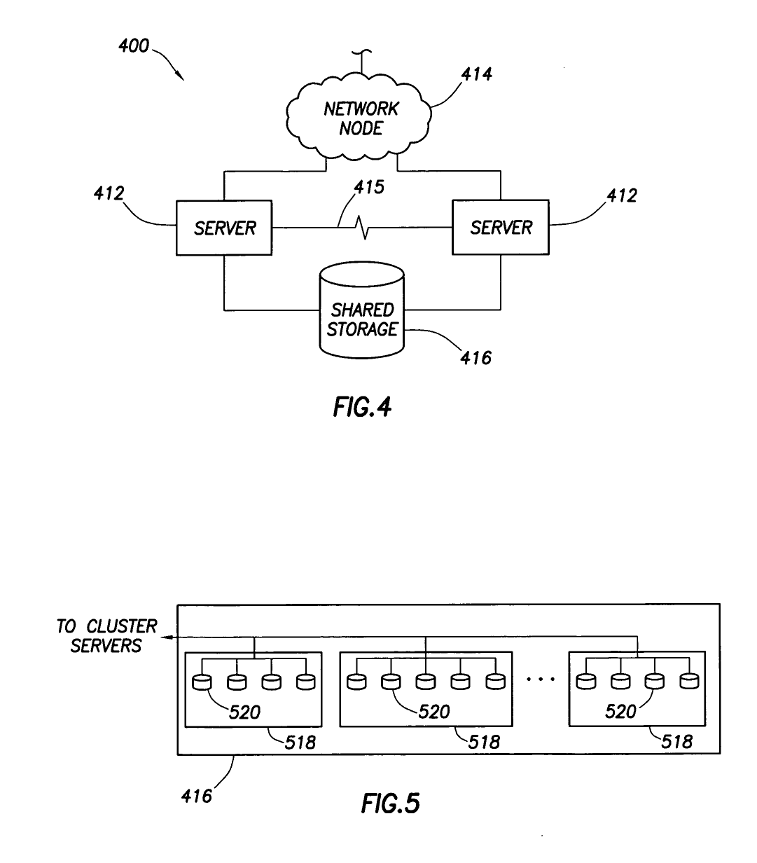

Shown in FIG. 4 is an exemplary embodiment of a two-node server cluster network 400. The server cluster network 400 may include one or more server nodes 412 that may be interconnected to one another by a heartbeat or communications link 415. Each of the server nodes 412 may be coupled to a network node 414, which represents a connection to a communications network served by the server nodes 412. Each of the server nodes 412 may be coupled to a shared storage unit 416. Shown in FIG. 5 is a diagram of the shared storage unit 416, which may include a number of drive arrays 518. Each of the drive arrays 518 may include a number of interconnected storage disks or drives 520 that may be managed according to a fault tolerant data storage methodology, such as a redundant array of inexpensive disks (RAID) methodology. The shared storage unit 416 of FIG. 5 is shown as having three drive arrays 518, although other configurations of shared storage unit 416 may have more or fewer drive arrays 518.

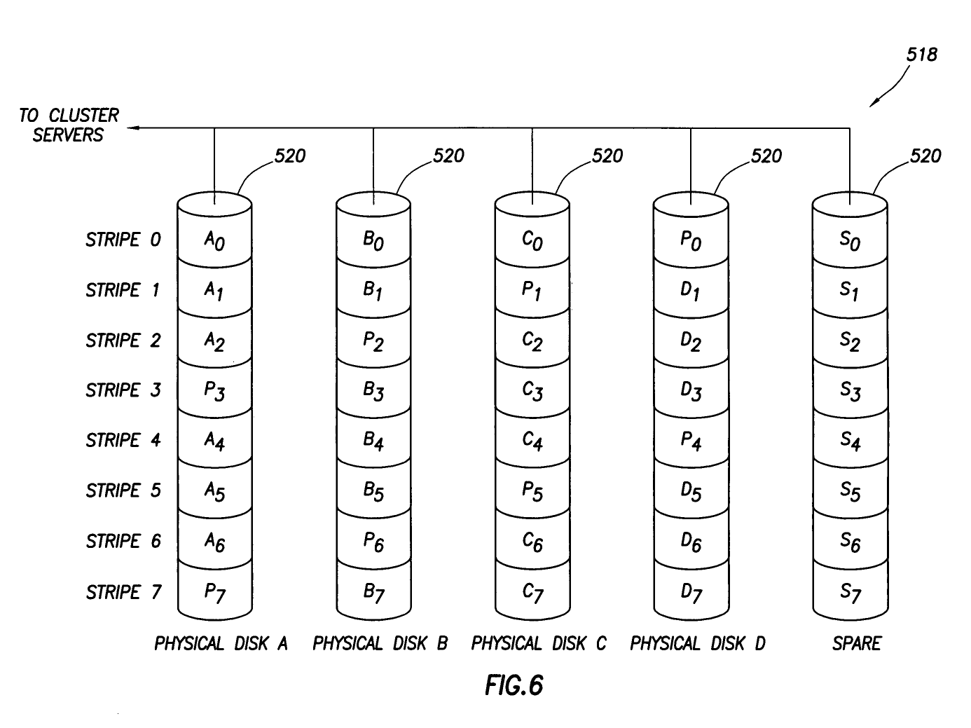

The storage drives 520 of the drive array 518 may operate according to a RAID Level 5 data storage scheme. RAID Level 5 is characterized by the inclusion of a parity strip in each stripe of data as a method of protecting the data of the stripe and of providing for the ability to rebuild or restore the data of the stripe on the basis of the data stored on the remaining strips of data in the data stripe. Shown generally at 518 in FIG. 6 is a diagram of a drive array that may include five data drives 520, labeled Physical Disk A through Physical Disk D, and a spare disk. Each of the four data disk drives 520 in the example of FIG. 6 may includes eight stripes or rows of data, labeled Stripe 0 through Stripe 7. It should be recognized that the configuration of the RAID array 518 of FIG. 6 is an illustration and that an implementation of a RAID array 518 may have more or fewer disk drives 520 with more or fewer stripes or rows, and may be of a different RAID level. The size or width of each stripe of data may be, for example, 64 KB per disk.

With reference to Stripe 0, data A₀, B₀, and C₀ may be stored in Disk A, Disk B, and Disk C, respectively. The parity bits for Stripe 0, which may be the result of an exclusive-OR operation performed on the content of Stripe 0 in Disk A, Disk B, and Disk C, may be stored in Disk D and may be labeled P₀. As a second example of the data structure of the RAID array 518, with reference to Stripe 7, B₇, C₇, and D₇ may be stored in Disk B, Disk C, and Disk D, respectively. The parity bits for Stripe 7, which may be the result of an exclusive-OR operation performed on the content of Stripe 7 in Disk B, Disk C, and Disk D, may be stored in Disk A and may be labeled P₇ . If, for example, Disk C were to fail or be replaced, the data in each stripe of Disk C would be rebuilt with the data in the other three disks of the RAID array 518.

The spare storage drive of RAID array 518 may likewise be arranged into a number of logical stripes that mirror the scheme used for the data or active storage drives 520. In this example, the spare storage drive may include seven stripes, labeled S₀-S₇. In normal operation, the spare storage drive is not used as part of the RAID Level 5 data storage scheme. Instead, the spare storage drive exists in the shared storage unit 416 (FIGS. 4 and 5) and can be associated with any one or more of the RAID arrays 518 for the sake of the firmware update process disclosed herein.

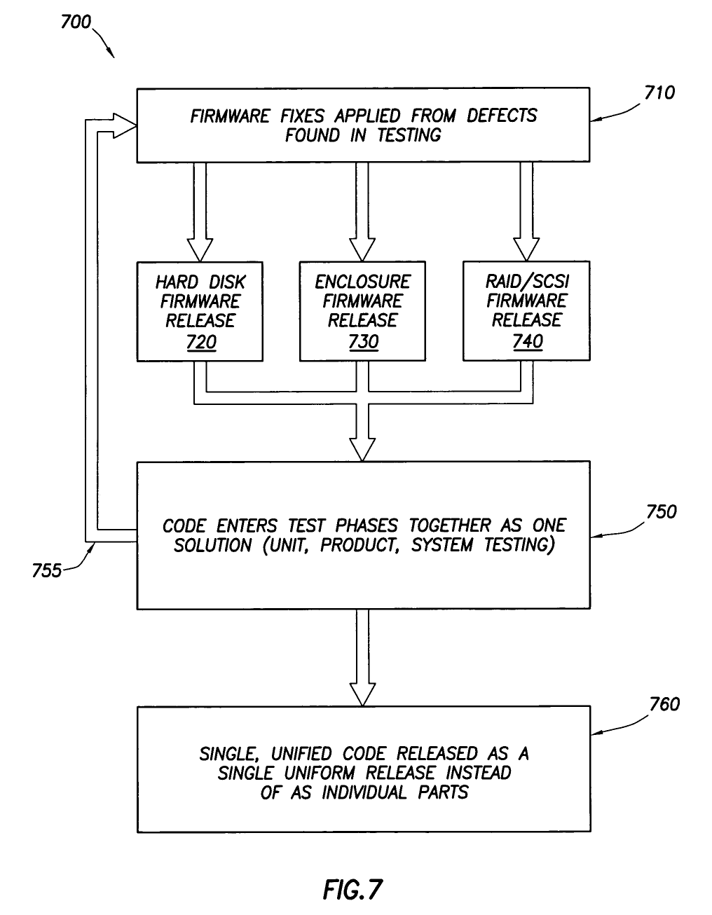

In various illustrative embodiments, a single release of firmware updates and/or upgrades that contains firmware code for all the pieces of the storage subsystem 200 may be created. FIG. 7 schematically illustrates a method 700 of creating a single release 760 that contains firmware code for all the pieces of the storage subsystem 200. Firmware fixes may be applied from various firmware defects found in scanning or testing the devices attached to the storage subsystem 200, as indicated at 710. For example, there may be an HDD drive firmware release 720, an enclosure firmware release 730, and a RAID/SCSI firmware release 740. As shown at 750, the HDD drive firmware release 720, the enclosure firmware release 730, and the RAID/SCSI firmware release 740 may enter test phases together as one solution, depending on the appropriate particular unit, product, system testing, and the like, with feedback, as shown at 755. A known compatible firmware stack, including the appropriate most up-to-date HDD drive firmware release 720, enclosure firmware release 730, and RAID/SCSI firmware release 740, for example, may then be released as a single unified code, as a single uniform release, as indicated at 760, instead of piecemeal, as in individual parts. This may ensure that users and/or customers receive a complete working solution of compatible firmware revisions.

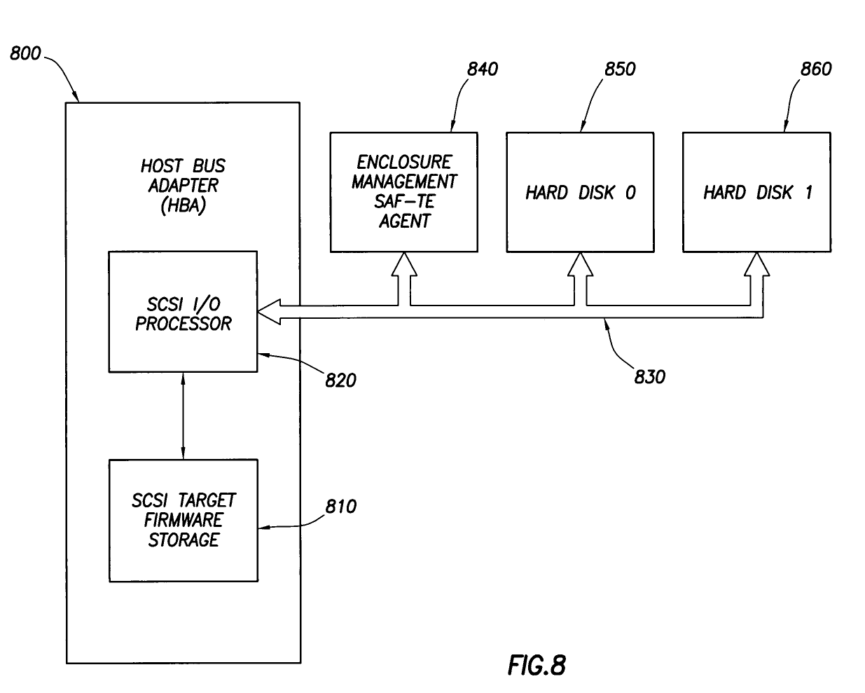

In various illustrative embodiments, a RAID/SCSI/SAS/FC controller may store copies of all the device firmware and may automatically upgrade down-revision devices that do not have the most up-to-date firmware revisions, for example. A host bus controller (HBC) may have a local storage device, such as a flash chip, a non-volatile random access memory (NVRAM), a battery-backed dynamic random access memory (DRAM), and the like, which may contain the appropriate updated and/or upgraded firmware for all the supported devices, for example. FIG. 8 schematically illustrates a host bus adapter (HBA) 800 including a local storage device such as a SCSI target firmware storage 810 that contains firmware code for all the supported pieces of the storage subsystem 200. The host bus adapter (HBA) 800 may also include a SCSI input/output (I/O) processor 820 communicatively coupled to a SCSI/SAS/FC bus 830. The SCSI/SAS/FC bus 830 may have plurality of SCSI/SAS/FC hardware devices attached thereto, such as an enclosure management SCSI accessed fault tolerant enclosure (SAF-TE) agent 840, and one or more hard disk drives (HDDs) 850 and/or 860.

In various illustrative embodiments, the SCSI target firmware storage 810 may store the firmware code for all the supported pieces of the storage subsystem 200 that has been released as the single unified code, as the single uniform release, as indicated at 760. In various illustrative embodiments, the SCSI target firmware storage 810 may have the firmware code for all the supported pieces of the storage subsystem 200 stored in the same flash chip as the code for the SCSI I/O processor 820. In various alternative illustrative embodiments, the SCSI target firmware storage 810 may have the firmware code for all the supported pieces of the storage subsystem 200 stored in a separate component from the flash chip in which the code for the SCSI I/O processor 820 may be stored.

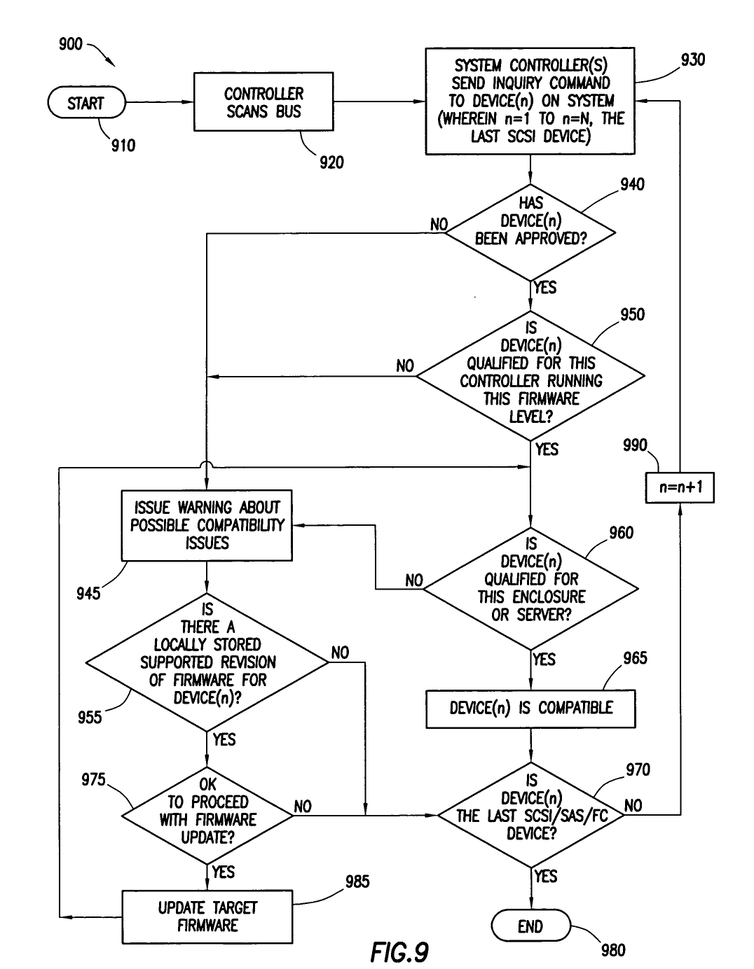

FIG. 9 schematically illustrates a flow chart of various exemplary embodiments of a method 900 for determining the compatibility of supported devices on the external SCSI bus 204 and/or on the internal SCSI bus 205. Although not specifically described below, the point-to-point SAS/FC link 314 may alternatively be substituted for the external SCSI bus 204. In various illustrious embodiments, a SCSI/SAS/FC interconnection may be substituted for the external SCSI bus 204, for example. The method 900 starts, as indicated by 910. For example, the SCSI subsystem 211 may boot. As indicated at 920, the controller 202 may scan a SCSI/SAS/FC interconnection such as the external SCSI bus 204 and/or the internal SCSI bus 205 to determine how many SCSI/SAS/FC devices are attached to the storage system 200. The scan may also be initiated upon boot-up, usually during the power-on self test (POST) operation, of the storage system 200.

System scans may also be initiated upon a change and/or alteration of the configuration of the storage system 200. Similarly, a scan may also be initiated upon the relocation of one or more of the SCSI/SAS/FC hardware devices within the storage system 200. For example, the internal HDD 206 may be replaced with the external HDD 210 and, upon such replacement, the storage system 200 may detect the change in configuration to cause the scan to be initiated.

Following the scan of the system, the controller 202 may send an inquiry command to each SCSI/SAS/FC hardware device on the system, as indicated at 930. For example, an inquiry command may be sent from at least one system controller, such as the controller 202, to read at least one specified field in device(n), where device(n) is one of the hardware devices, such as the HDD 206 and/or the HDD 210, attached to the SCSI/SAS/FC interconnection, such as the external SCSI bus 204 and/or the internal SCSI bus 205 and/or the point-to-point SAS/FC link 314, and n is in the range of n=1 to n=N, where there are N total SCSI/SAS/FC devices attached to the external SCSI bus 204 and/or the internal SCSI bus 205 and/or the point-to-point SAS/FC link 314. In various other illustrative embodiments, compatibility information may be obtained via a mode select command. Because a determination is made for each device on the system, the method 900 may repeat the scan process for each SCSI/SAS/FC device(n). However, in some instances, the inquiry command may take place substantially simultaneously with all of the SCSI/SAS/FC devices located on the SCSI/SAS/FC interconnection, SCSI/SAS/FC device(n) for n=1 to n=N.

Based on the inquiry command, each SCSI/SAS/FC device(n) may respond with a respective revision status of the firmware for each SCSI/SAS/FC device(n) attached to the SCSI/SAS/FC interconnection. The controller 202 may determine an interconnection compatibility of each SCSI/SAS/FC device(n) attached to the SCSI/SAS/FC interconnection based on checking, verifying, and flagging the revision status of the firmware for each of the hardware devices attached to the SCSI/SAS/FC interconnection. The controller 202 may then further determine the interconnection compatibility by reading back version information of the firmware for each SCSI/SAS/FC device(n) attached to the SCSI/SAS/FC interconnection and checking the version information against the locally stored supported revision of the firmware for each SCSI/SAS/FC device(n) attached to the SCSI/SAS/FC interconnection, flagging each each SCSI/SAS/FC device(n) attached to the SCSI/SAS/FC interconnection having at least one of old firmware, out of date firmware, incompatible firmware, and/or untested firmware.

In various illustrative embodiments, for example, a SCSI/SAS/FC device on the SCSI/SAS/FC interconnection, such as the host bus adapter (HBA) 800, has the ability to check and verify the software and/or firmware revision information inside each SCSI/SAS/FC device(n) attached to the SCSI/SAS/FC interconnection. For example, the host bus adapter (HBA) 800 may send an inquiry command to each SCSI/SAS/FC device(n) attached to the SCSI/SAS/FC interconnection and read back at least the version information of the firmware for each SCSI/SAS/FC device(n) attached to the SCSI/SAS/FC interconnection. This version information of the firmware for each SCSI/SAS/FC device(n) attached to the SCSI/SAS/FC interconnection may then be checked against the respective firmware revision included in the locally stored supported 810 SCSI/SAS/FC single uniform release of firmware 760. If the firmware for a particular SCSI/SAS/FC device(n) attached to the SCSI/SAS/FC interconnection is old, out of date, incompatible, and/or untested, that particular SCSI/SAS/FC device(n) attached to the SCSI/SAS/FC interconnection may be flagged. The host bus adapter (HBA) 800 may be provided with the intelligence and code algorithm, through the locally stored supported 810 SCSI/SAS/FC single uniform release of firmware 760, for example, to upgrade and/or flash any SCSI/SAS/FC device(n) attached to the SCSI/SAS/FC interconnection that had been flagged and for which the host bus adapter (HBA) 800 may have a method and/or the “know how” to flash and/or the appropriate code for the flagged SCSI/SAS/FC hardware device. Incompatible SCSI/SAS/FC hardware devices attached to the SCSI/SAS/FC interconnection that had been flagged that may not have appropriate firmware included in the SCSI/SAS/FC single uniform release of firmware 760 may not be upgraded, but the user may be warned about possible incompatibility issues, as indicated at 945, where a user may be notified of one or more possible compatibility issues.

Based on the SCSI/SAS/FC bus scan response, the SCSI/SAS/FC device(n) may be considered approved such that the controller 202 may continue to determine the compatibility of the SCSI/SAS/FC device(n) based on the hardware and/or firmware configurations. As indicated at 950, the controller 202 may determine whether the SCSI/SAS/FC device(n) is compatible and/or validated and/or qualified with the controller 202 and/or any other controller located within storage system 200 running the particular firmware level run by the SCSI/SAS/FC device(n) device, for example. Similarly, if such a compatibility issue arises, the SCSI/SAS/FC device(n) may be deemed not valid and/or supported such that the warning may be issued for one or more potential compatibility issues, as indicated at 945, as described above.

If the controller 202 is compatible and/or validated and/or qualified for the SCSI/SAS/FC device(n), the determination may be made of whether or not the enclosure 212 and/or another I/O expander may be compatible with and/or validated with and/or qualified for the SCSI/SAS/FC device(n), as indicated at 960. Similarly, if the SCSI/SAS/FC device(n) is not supported and/or validated, the SCSI/SAS/FC device(n) may be deemed not compatible and/or not valid and/or not qualified such that the warning may be issued for one or more potential compatibility issues, as indicated at 945, as described above.

If the SCSI/SAS/FC device(n) has been approved and/or validated for the controller 202 and qualified and/or validated for the enclosure 212, the method 900 may determine that the SCSI/SAS/FC device(n) may be compatible with the current hardware and/or firmware configuration(s) in the storage system 200, as indicated at block 965. Next, the method 900 may check to determine if this is the last SCSI/SAS/FC device(n=N) whose hardware and/or firmware configuration(s) is to be determined in the storage system 200, as indicated at 970. If this is not the last SCSI/SAS/FC device(n=N), the next SCSI/SAS/FC device(n) in the storage system 200 may be selected, as indicated at 990, wherein “device(n)” may be incremented to the next device(n) value, as shown by “n=n+1.” Thus, the method 900 of determining compatibility may be continued until all SCSI/SAS/FC devices attached to the system 200 may have had their respective compatibility issues determined.

The method 900 may include determining whether or not a supported revision of firmware for each of the SCSI/SAS/FC hardware devices attached to the SCSI/SAS/FC interconnection is locally stored 810 as the single uniform release 760, based on determining the interconnection compatibility of each of the SCSI/SAS/FC hardware devices attached to the SCSI/SAS/FC interconnection, as indicated at 955. If there is no locally stored supported 810 revision of firmware for the SCSI/SAS/FC device(n) in the SCSI/SAS/FC single uniform release of firmware 760, the method 906 may check to determine if this is the last SCSI/SAS/FC device(n=N) whose hardware and/or firmware configuration(s) is to be determined in the storage system 200, as indicated at 970.

If there is a locally stored supported 810 revision of firmware for the SCSI/SAS/FC device(n) in the SCSI/SAS/FC single uniform release of firmware 760, the method 900 may proceed to prompt the user, as indicated at 975, asking whether or not to proceed with a firmware upgrade for the SCSI/SAS/FC device(n) attached to the SCSI/SAS/FC interconnection using the locally stored supported 810 revision of firmware for the SCSI/SAS/FC device(n) in the SCSI/SAS/FC single uniform release of firmware 760, based on determining the SCSI/SAS/FC interconnection compatibility of each of the SCSI/SAS/FC hardware devices attached to the SCSI/SAS/FC interconnection. If the user decides not to proceed with the firmware upgrade for the SCSI/SAS/FC device(n) attached to the SCSI/SAS/FC interconnection using the locally stored supported 810 revision of firmware for the SCSI/SAS/FC device(n) in the SCSI/SAS/FC single uniform release of firmware 760, the method 900 may check to determine if this is the last SCSI/SAS/FC device(n=N) whose hardware and/or firmware configuration(s) is to be determined in the storage system 200, as indicated at 970.

If the user decides to proceed with the firmware upgrade for the SCSI/SAS/FC device(n) attached to the SCSI/SAS/FC interconnection using the locally stored supported 810 revision of firmware for the SCSI/SAS/FC device(n) in the SCSI/SAS/FC single uniform release of firmware 760, the method 900 proceeds to update and/or upgrade automatically the firmware for the SCSI/SAS/FC device(n) attached to the SCSI/SAS/FC interconnection, based on prompting the user, as indicated at 985. The method 900 may then proceed, as described above, yet again to determine whether or not the enclosure 212 and/or another I/O expander may be compatible with and/or validated with and/or qualified for the SCSI/SAS/FC device(n), as indicated at 960. In various illustrative embodiments, no firmware upgrades may be performed unless approved by the end user. In various illustrative exemplary embodiments, the host bus adapter (HBA) 800 may use the SCSI/SAS/FC write buffer commands to communicate the appropriate binary code data to the SCSI/SAS/FC device(n) attached to the SCSI/SAS/FC interconnection, for example.

As described above, the system and method disclosed herein are advantageous in that upon the discovery of a supported but down revision hardware device, with non-updated firmware, attached to an interconnection in an information handling system, the host bus adapter (HBA) 800, for example, in the information handling system may prompt the user and then proceed with a firmware upgrade that brings the supported hardware device to a known compatible firmware revision, compatible with other hardware devices also attached to the interconnection in the information handling system. The system and method disclosed herein are further advantageous in that there may also be an improvement in the user or customer experience. For example, since the host bus adapter (HBA) 800 has the ability to update all of the hardware devices attached to the small computer system interface (SCSI) bus 204 and/or 205 and/or the serial attached SCSI (SAS) point-to-point SAS/FC link 314, the user and/or customer does not have to use separate software tools to flash individual hardware devices. Users and/or customers may do only one single flash process and the host bus adapter (HBA) 800 will automatically push firmware out to the respective hardware devices as needed. Moreover, at the end of the upgrade process, users and/or customers may be using a storage array in an information handling system, for example, having all the hardware devices therein in a known compatible state.

In various illustrative embodiments, for the enclosure 212 updates, the SCSI enclosure services (SES) string out command may be used in conjunction with the SES string in command to send the firmware image down to the device. The downloadable firmware may be in binary format and may be broken down into multiple packets and may be passed to the enclosure management module (EMM) using the SES string out page. The maximum size of such a packet may be about a kilobyte (1 kB). Substantially no preprocessing on the file may be required since all relevant data is already compiled into this downloadable file.

For the hard disk drive (HDD) 206 and/or 210 updates, in various illustrative embodiments, the firmware download may use the SCSI write buffer command mode 5 and/or 7 for downloading microcode and/or saving. For the backplane 201 updates, in various illustrative embodiments, the SES string out command may be used in conjunction with the SES string in command to send the firmware image down to the device, and a method similar to that used for the enclosure 212 updates, as described above, may be used. In various alternative illustrative embodiments, for the backplane 201 updates, the sideband i2c/SMBUS signals may be used, if available.

In various illustrative embodiments, the SCSI/SAS/FC firmware for all supported devices may be packaged as a single uniform release, as described above in FIG. 7 and the accompanying disclosure. This single uniform release may be tested for interoperability beforehand. This may also provide a better customer solution because the customers do not have to use different utilities to flash different devices.

In various illustrative embodiments, device compatibility detection may be provided by having a SCSI/SAS/FC device on the SCSI/SAS/FC bus, such as the host bus adapter (HBA) 800, for example, have the ability to check and verify software revision information inside each SCSI/SAS/FC device on the SCSI/SAS/FC bus. For example, the host bus adapter (HBA) 800 may send an inquiry command to the hard disk drive (HDD) 850 and read back the SCSI/SAS/FC device firmware. This version information may be checked against the firmware revision included in the SCSI/SAS/FC single uniform release. If the firmware is old, out of date, incompatible, and/or untested, that hard disk drive (HDD) 850 may be flagged. This example may also be applicable to hard disk drive enclosures, SAFE-TE devices and anything elses on the SCSI/SAS/FC bus.

In various illustrative embodiments, the intelligence and/or code algorithm may be provided to the SCSI/SAS/FC device on the SCSI/SAS/FC bus, such as the host bus adapter (HBA) 800, for example, so that the host bus adapter (HBA) 800 may upgrade and/or flash any of the SCSI/SAS/FC devices on the SCSI/SAS/FC bus that had been flagged, during the device compatibility detection process described above, and for which the host bus adapter (HBA) 800 has a method and/or knows how to flash and has the resepctive code for the flagged device in the SCSI/SAS/FC single uniform release. Incompatible devices that do not have the respective firmware included in the SCSI/SAS/FC single uniform release may not be upgraded, but the user may simply be warned about possible compatibility issues. No firmware upgrades may be performed unless approved by the end user. In various illustrative particular embodiments, the host bus adapter (HBA) 800 may use the SCSI/SAS/FC write buffer commands to communicate the binary code data to the respective hard disk drive (HDD) 850, for example.

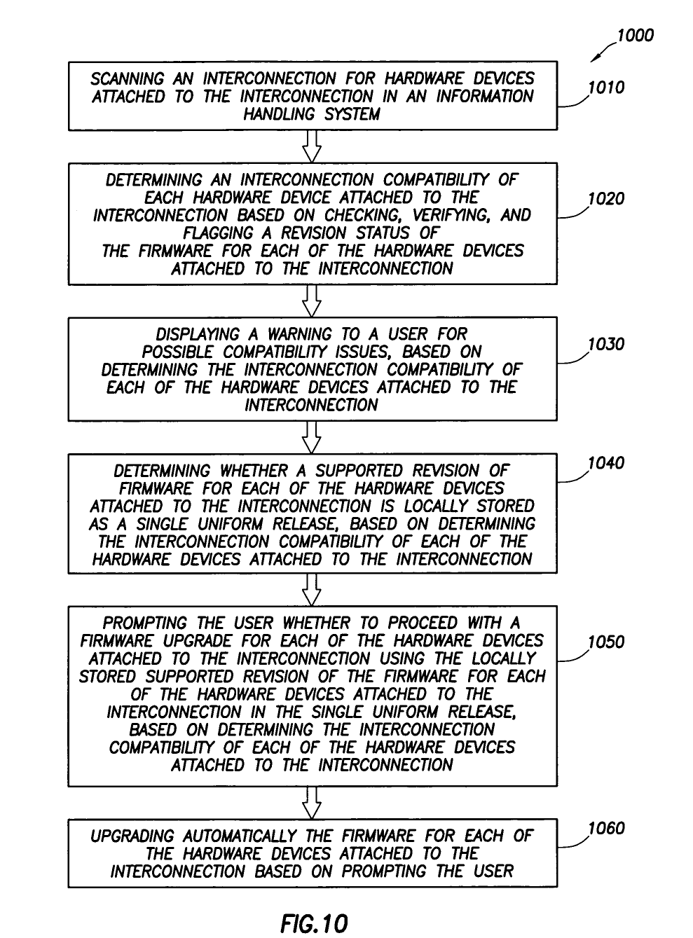

In various illustrative embodiments, as shown in FIG. 10, a method 1000 of automatic enforcement of firmware revision in an information handling system may be provided. The method 1000 may comprise scanning an interconnection for hardware devices attached to the interconnection in an information handling system, as indicated at 1010, determining an interconnection compatibility of each hardware device attached to the interconnection based on checking, verifying, and flagging a revision status of the firmware for each of the hardware devices attached to the interconnection, as indicated at 1020, and displaying a warning to a user about possible compatibility issues, based on determining the interconnection compatibility of each of the hardware devices attached to the interconnection, as indicated at 1030. The method 1000 may also comprise determining whether a supported revision of firmware for each of the hardware devices attached to the interconnection is locally stored as a single uniform release, based on determining the interconnection compatibility of each of the hardware devices attached to the interconnection, as indicated at 1040, prompting the user whether to proceed with a firmware upgrade for each of the hardware devices attached to the interconnection using the locally stored supported revision of the firmware for each of the hardware devices attached to the interconnection in the single uniform release, based on determining the interconnection compatibility of each of the hardware devices attached to the interconnection, as indicated at 1050, and upgrading automatically the firmware for each of the hardware devices attached to the interconnection based on prompting the user, as indicated at 1060.

The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a−b”) disclosed herein is to be understood as referring to the power set (the set of all subsets) of the respective range of values, in the sense of Georg Cantor. Accordingly, the protection sought herein is as set forth in the claims below.

Although various illustrative embodiments of the present invention and their advantages are described in detail, a person skilled in the art having the benefit of the present disclosure could make various alterations, additions, and/or omissions without departing from the spirit and scope of the present invention, as defined by the appended claims.

What is claimed is:

1. A method of automatic enforcement of firmware revision in an information handling system, the method comprising:
scanning an interconnection for hardware devices attached to the interconnection in an information handling system;
determining an interconnection compatibility of each hardware device attached to the interconnection based on checking, verifying, and flagging a revision status of the firmware for each of the hardware devices attached to the interconnection;
displaying a warning to a user about possible compatibility issues, based on determining the interconnection compatibility of each of the hardware devices attached to the interconnection;
determining whether a supported revision of firmware for each of the hardware devices attached to the interconnection is locally stored as a single uniform release, based on determining the interconnection compatibility of each of the hardware devices attached to the interconnection;
prompting the user whether to proceed with a firmware upgrade for each of the hardware devices attached to the interconnection using the locally stored supported revision of the firmware for each of the hardware devices attached to the interconnection in the single uniform release, based on determining the interconnection compatibility of each of the hardware devices attached to the interconnection; and
upgrading automatically the firmware for each of the hardware devices attached to the interconnection based on prompting the user.

2. The method of claim 1, wherein scanning the interconnection further comprises performing the scan during at least one of a power on self test (POST) and a boot-up sequence of the information handling system.

3. The method of claim 2, wherein performing the scan of the interconnection further comprises performing the scan during the boot-up sequence of the information handling system.

4. The method of claim 3, wherein performing the scan of the interconnection further comprises performing the scan during the boot-up sequence of the information handling system comprising at least one small computer system interface (SCSI) subsystem and determining how many hardware devices are attached to the interconnection comprising at least one SCSI bus.

5. The method of claim 1, wherein determining the interconnection compatibility of each of the hardware devices attached to the interconnection further comprises sending an inquiry command from at least one system controller to read at least one specified field in each of the hardware devices attached to the interconnection.

6. The method of claim 1, wherein determining the interconnection compatibility of each of the hardware devices attached to the interconnection further comprises sending an inquiry command from at least one system controller to read at least one specified field in device(n), wherein device(n) is one of the hardware devices attached to the interconnection and n is in the range of n=1 to n=N, wherein there are N total hardware devices attached to the interconnection comprising at least one SCSI/SAS/FC bus.

7. The method of claim 5, wherein determining the interconnection compatibility of each of the hardware devices attached to the interconnection further comprises reading back version information of the firmware for each of the hardware devices attached to the interconnection and checking the version information against the locally stored supported revision of the firmware for each of the hardware devices attached to the interconnection, flagging each of the hardware devices attached to the interconnection having at least one of old firmware, out of date firmware, incompatible firmware, and untested firmware.

8. The method of claim 6, wherein determining the interconnection compatibility of each of the hardware devices attached to the interconnection further comprises reading back version information of the firmware for each of the hardware devices attached to the interconnection and checking the version information against the locally stored supported revision of the firmware for each of the hardware devices attached to the interconnection, flagging each of the hardware devices attached to the interconnection having at least one of old firmware, out of date firmware, incompatible firmware, and untested firmware.

9. A method of automatic enforcement of firmware revision in an information handling system comprising at least one of a small computer system interface (SCSI) subsystem, a serial attached SCSI (SAS) subsystem, and a fiber channel (FC) subsystem, the method comprising:
starting by booting up the at least one of the SCSI subsystem, the SAS subsystem, and the FC subsystem;
using a controller to scan an interconnection comprising at least one of a SCSI bus, an SAS bus, and an FC bus for hardware devices attached to the interconnection in the information handling system;
determining an interconnection compatibility of each hardware device attached to the interconnection by sending an inquiry command from at least one system controller to read at least one specified field in device(n), wherein device(n) is one of the hardware devices attached to the interconnection and n is in the range of n=1 to n=N, wherein there are N total hardware devices attached to the interconnection, based on checking, verifying, and flagging a revision status of the firmware for the device(n) attached to the interconnection;
issuing and displaying a warning to a user about possible compatibility issues, based on determining the interconnection compatibility of the device(n) attached to the interconnection;
determining whether a supported revision of firmware is locally stored as a single uniform release for the device(n) attached to the interconnection, based on determining the interconnection compatibility of the device(n) attached to the interconnection;
prompting the user whether to proceed with a firmware upgrade for the device(n) attached to the interconnection using the locally stored supported revision of the firmware for each of the hardware devices attached to the interconnection in the single uniform release, based on determining the interconnection compatibility of the device(n) attached to the interconnection; and
upgrading automatically the firmware for the device(n) attached to the interconnection based on prompting the user.

10. The method of claim 9, wherein scanning the interconnection further comprises performing the scan during at least one of a power on self test (POST) and a boot-up sequence of the information handling system.

11. The method of claim 10, wherein performing the scan of the interconnection further comprises performing the scan during the boot-up sequence of the information handling system.

12. The method of claim 11, wherein performing the scan of the interconnection further comprises determining how many hardware devices are attached to the interconnection comprising at least one SCSI/SAS/FC bus.

13. The method of claim 9, wherein determining the interconnection compatibility of each of the hardware devices attached to the interconnection further comprises reading back version information of the firmware for each of the hardware devices attached to the interconnection and checking the version information against the locally stored supported revision of the firmware for each of the hardware devices attached to the interconnection, flagging each of the hardware devices attached to the interconnection having at least one of old firmware, out of date firmware, incompatible firmware, and untested firmware.

14. The method of claim 10, wherein determining the interconnection compatibility of each of the hardware devices attached to the interconnection further comprises reading back version information of the firmware for each of the hardware devices attached to the interconnection and checking the version information against the locally stored supported revision of the firmware for each of the hardware devices attached to the interconnection, flagging each of the hardware devices attached to the interconnection having at least one of old firmware, out of date firmware, incompatible firmware, and untested firmware.

15. The method of claim 11, wherein determining the interconnection compatibility of each of the hardware devices attached to the interconnection further comprises reading back version information of the firmware for each of the hardware devices attached to the interconnection and checking the version information against the locally stored supported revision of the firmware for each of the hardware devices attached to the interconnection, flagging each of the hardware devices attached to the interconnection having at least one of old firmware, out of date firmware, incompatible firmware, and untested firmware.

16. A system for automatic enforcement of firmware revision in an information handling system comprising at least one of a small computer system interface (SCSI) subsystem, a serial attached SCSI (SAS) subsystem, and a fiber channel (FC) subsystem, the system comprising:
a host bus adapter (HBA) comprising a SCSI input/output (I/O) processor and SCSI target firmware storage;
a SCSI/SAS/FC interconnection communicatively coupled to the host bus adapter (HBA); and
a plurality of hardware devices communicatively coupled to the SCSI/SAS/FC interconnection communicatively coupled to the host bus adapter (HBA), wherein the host bus adapter (HBA) is operable to update firmware in the plurality of the hardware devices communicatively coupled to the SCSI/SAS/FC interconnection communicatively coupled to the host bus adapter (HBA), the host bus adapter (HBA) capable of automatically pushing the firmware in a single flash process to the plurality of the hardware devices communicatively coupled to the SCSI/SAS/FC interconnection communicatively coupled to the host bus adapter (HBA).

17. The system of claim 16 further comprising:
a controller communicatively coupled to the SCSI/SAS/FC interconnection, the controller operable to scan the SCSI/SAS/FC interconnection for the hardware devices attached to the SCSI/SAS/FC interconnection, to determine a SCSI/SAS/FC interconnection compatibility of each hardware device attached to the SCSI/SAS/FC interconnection based on checking, verifying, and flagging a revision status of the firmware for each of the hardware devices attached to the SCSI/SAS/FC interconnection, to display a warning to a user about possible compatibility issues, based on determining the SCSI/SAS/FC interconnection compatibility of each of the hardware devices attached to the SCSI/SAS/FC interconnection, to determine whether a supported revision of firmware for each of the hardware devices attached to the SCSI/SAS/FC interconnection is locally stored as a single uniform release, based on determining the SCSI/SAS/FC interconnection compatibility of each of the hardware devices attached to the SCSI/SAS/FC interconnection, to prompt the user whether to proceed with a firmware upgrade for each of the hardware devices attached to the SCSI/SAS/FC interconnection using the locally stored supported revision of the firmware for each of the hardware devices attached to the SCSI/SAS/FC interconnection in the single uniform release, based on determining the SCSI/SAS/FC interconnection compatibility of each of the hardware devices attached to the SCSI/SAS/FC interconnection, and to upgrade automatically the firmware for each of the hardware devices attached to the SCSI/SAS/FC interconnection based on prompting the user.

18. The system of claim 16, wherein the host bus adapter (HBA) is operable to scan the SCSI/SAS/FC interconnection for the hardware devices attached to the SCSI/SAS/FC interconnection, to determine a SCSI/SAS/FC interconnection compatibility of each hardware device attached to the SCSI/SAS/FC interconnection based on checking, verifying, and flagging a revision status of the firmware for each of the hardware devices attached to the SCSI/SAS/FC interconnection, to display a warning to a user about possible compatibility issues, based on determining the SCSI/SAS/FC interconnection compatibility of each of the hardware devices attached to the SCSI/SAS/FC interconnection, to determine whether a supported revision of firmware for each of the hardware devices attached to the SCSI/SAS/FC interconnection is locally stored as a single uniform release, based on determining the SCSI/SAS/FC interconnection compatibility of each of the hardware devices attached to the SCSI/SAS/FC interconnection, to prompt the user whether to proceed with a firmware upgrade for each of the hardware devices attached to the SCSI/SAS/FC interconnection using the locally stored supported revision of the firmware for each of the hardware devices attached to the SCSI/SAS/FC interconnection in the single uniform release, based on determining the SCSI/SAS/FC interconnection compatibility of each of the hardware devices attached to the SCSI/SAS/FC interconnection, and to upgrade automatically the firmware for each of the hardware devices attached to the SCSI/SAS/FC interconnection based on prompting the user.

19. The system of claim 17, wherein the controller is operable to perform a target firmware check on each of the hardware devices attached to the SCSI/SAS/FC interconnection, reading back version information of the firmware for each of the hardware devices attached to the SCSI/SAS/FC interconnection and checking the version information against the locally stored supported revision of the firmware for each of the hardware devices attached to the SCSI/SAS/FC interconnection, flagging each of the hardware devices attached to the SCSI/SAS/FC interconnection having at least one of old firmware, out of date firmware, incompatible firmware, and untested firmware.

20. The method of claim 18, wherein the host bus adapter (HBA) is operable to perform a target firmware check on each of the hardware devices attached to the SCSI/SAS/FC interconnection, reading back version information of the firmware for each of the hardware devices attached to the SCSI/SAS/FC interconnection and checking the version information against the locally stored supported revision of the firmware for each of the hardware devices attached to the SCSI/SAS/FC interconnection, flagging each of the hardware devices attached to the SCSI/SAS/FC interconnection having at least one of old firmware, out of date firmware, incompatible firmware, and untested firmware.
